(19) United States
(12) Patent Application Publication
(10) Pub. No.: US 2009/0009056 A1
(43) Pub. Date: Jan. 8, 2009

(54) LIGHT-EMITTING APPARTUS

(75) Inventors: Atsushi NAMBA, Tokyo (JP); Toshiya ARAKAWA, Tokyo (JP); Kunio NAKAZATO, Tokyo (JP); Hisaya TAKAHASHI, Yokohama-shi (JP); Tadashi ENDO, Tokyo (JP); Goro YAMAGUCHI, Tokyo (JP); Mineto IWASAKI, Tosu-shi (JP)

Correspondence Address: HAYNES AND BOONE, LLP;IP Section, 2323 Victory Avenue, Suite 700, Dallas, TX, 75219, US

(73) Assignees: FUJI JUKOGYO KABUSHIKI KAISHA, Tokyo (JP); SHOEI CHEMICAL INC., Tokyo (JP)

(21) Appl. No.: 12/167,830

(22) Filed: Jul. 3, 2008

(30) Foreign Application Priority Data
Jul. 3, 2007 (JP) 2007-175650
Jun. 25, 2008 (JP) 2008-165394

(51) Int. Cl. H01J 1/62

(52) U.S. Cl. 313/498

(57) ABSTRACT

A light emitting apparatus capable of efficiently generating high luminance white light is provided. The present invention permits white light to be generated, without using low-emission efficiency white light emitters, by forming a light emitter layer 16 using a high-light emission efficiency blue light emitter and yellow light emitter. In this case, having at least a part of the blue light emitter particles 17 and at least a part of the yellow light emitter particles 18 exposed at a surface of the light emitter layer 16, respectively, allows both of such particles to be directly bombarded with electrons, thereby effecting a highly efficient electron excitation. Furthermore, the use of YAG or the like, as a yellow light emitter, which emits yellow light not only by electron excitation but also through photoexcitation by the blue light, permits said blue light to contribute to the emission of the yellow light, even when part of the blue light emitted by the blue light emitter particles, as it passes through the light emitter layer 16, is blocked by the yellow light emitter particles 18, whereby white light can be generated efficiently with a reduction in energy loss.

### CROSS REFERENCE TO RELATED APPLICATIONS

This application claims priority under 35 U.S.C. 119 based upon Japanese Patent Application Serial No. 2007-175650, filed on Jul. 3, 2007 and Japanese Patent Application Serial No. 2008-165394, filed on Jun. 25, 2008. The entire disclosures of the aforesaid applications are incorporated herein by reference.

### FIELD OF THE INVENTION

The present invention relates to a light emitting apparatus for generating white light by allowing a light emitter (fluorescent material) to emit light upon excitation by field-emitted electrons from a cold-cathode electron emission source.

### BACKGROUND OF THE INVENTION

In recent years, as alternatives to the conventional light emitting apparatuses such as incandescent light bulbs, fluorescent lamps, and the like, there have been developed cold-cathode electron emission type light emitting apparatuses which involve impinging field-emitted electrons from a cold-cathode electron emission source at a high speed on a light emitter (fluorescent material) thereby exciting the light emitter to emit light, and such devices are expected to find applications such as field emission type illumination lamps (Field Emission Lamp: FEL) and field emission type displays (Field Emission Display: FED).

Of these light-emitting devices, manufacturing processes for FEDs in general often use various micron-order micro-processes in accordance with pixel size and the like. For example, in the manufacturing steps for FEDs, a cathode (cathode electrode) is formed on insulating substrates such as glass, ceramics, and the like by well-known micro-processes used for semiconductor chips and the like, such as the sputtering method and CVD method, and the like. Further, gate electrodes are formed by forming a columnar molten material, directly on an insulating substrate or as connected to a wiring layer on a surface of an insulating substrate, followed by fixating to the columnar molten material a 30 to 60 μm thick, thin metal sheet having a plurality of openings 10 to 100 μm in diameter made therein.

On the other hand, FELs with their applications specified to lamp light sources and the like, do not require their cathodes and the like to receive a micron-order fine processing as with FED's and the like; it is also sufficient for the openings made in the gate electrodes to have only relatively large, millimeter-order diameters (for example, see patent reference 1 (JP 2006-339012, A)).

Therefore, in the manufacture of FELs, eliminating micro-processing which incurs much capital-intensive investment cost or the like, along with manufacturing various functional parts of interest by combining parts that are mass-producible by atmospheric processes alone is expected to substantially reduce the cost thereof. It is conceivable to manufacture FELs at low cost, for example, by fabricating a cathode electrode and gate electrode respectively with individual functional parts from metal sheet substrates about several tenths mm in thickness, and assembling them in a vacuum chamber.

It is noted herein that this type of FEL is required to emit white light in many cases such as when used as illumination light sources.

However, while many developments have been made of highly luminous light emitters regarding light emitters that emit white light upon excitation by ultraviolet, as with light emitters widely used in general in fluorescent tubes, light emitters that emit white light by excitation with electrons have not yet presently been developed which emit at sufficiently high luminance.

Therefore, in the case such as that of FELs, if an attempt were made to produce white light by providing an anode with a light emitter that emits white light upon excitation, there would be a risk of causing much energy loss in the light emitter layer, making it difficult to efficiently generate high luminance white light.

It is an object of the present invention addressing the foregoing problems to provide a light emitting apparatus capable of efficiently emitting high luminance white light.

### SUMMARY OF THE INVENTION

According the present invention, there is provides a light emitting apparatus, comprising, in a vacuum chamber,

a cathode having a cold cathode emission source formed thereon;

an anode having a light emitter layer, which is formed on a surface facing the cathode, and in which multiple types of light emitters that emit light upon excitation by field-emitted electrons from the cold cathode emission source are mixed; wherein

the multiple types of light emitters are each related such that white light is generated by a mixing of each emitted light, and are each dispersed in the light emitter layer so that at least a part of each emitter is exposed directly to the field-emitted electrons; and wherein

at least one type of the light emitters also specifically emits light upon excitation by the light from another type of the light emitters.

In accordance with the light emitting apparatus of the present invention, high luminance white light can be generated efficiently.

### BRIEF DESCRIPTION OF THE DRAWINGS

FIG. 1 is a basic construction view of a light emitting apparatus.

FIG. 2 is an expanded schematic view of a light emitter layer.

FIG. 3 is an explanatory view of light emission upon excitation of a blue light emitter and a yellow light emitter.

FIG. 4 is a diagram showing a luminance distribution of light emitted by a blue light emitter unit, a yellow light emitter unit, and each light emitter layer of a mixture thereof.

FIG. 5 is a diagram showing the relationship between the weight ratio of the blue light emitter and yellow light emitter in a light emitter layer and luminance thereof.

### DETAILED DESCRIPTION OF THE INVENTION

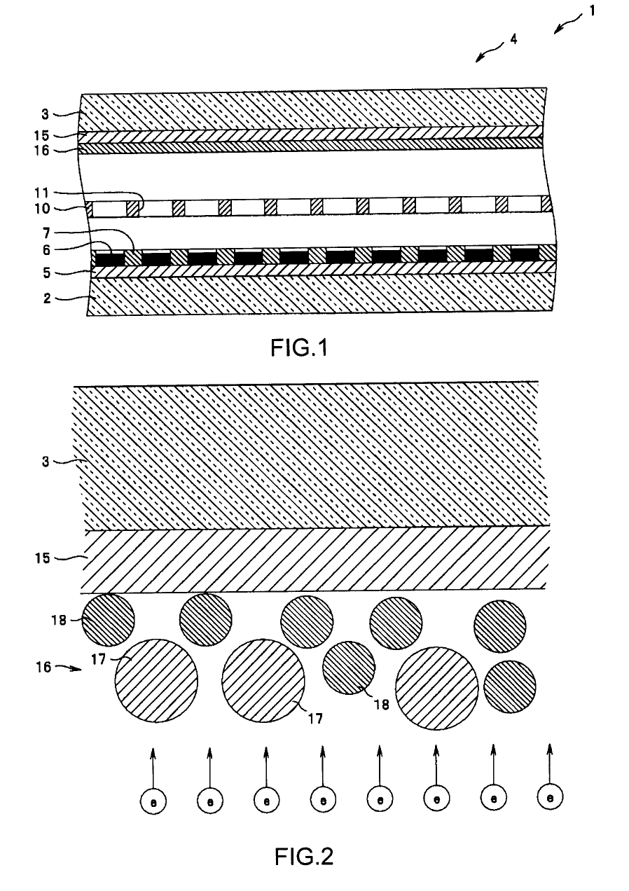

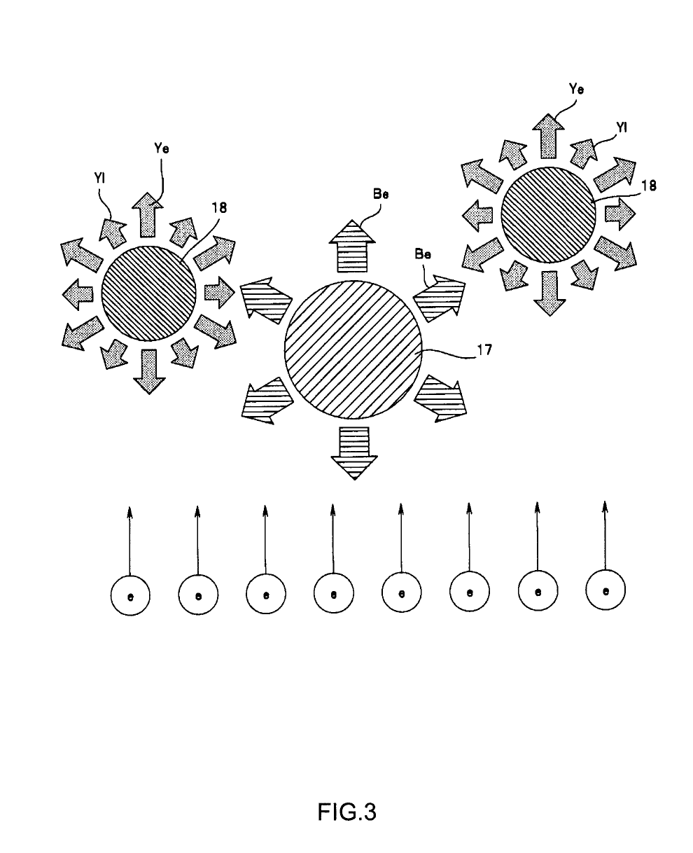

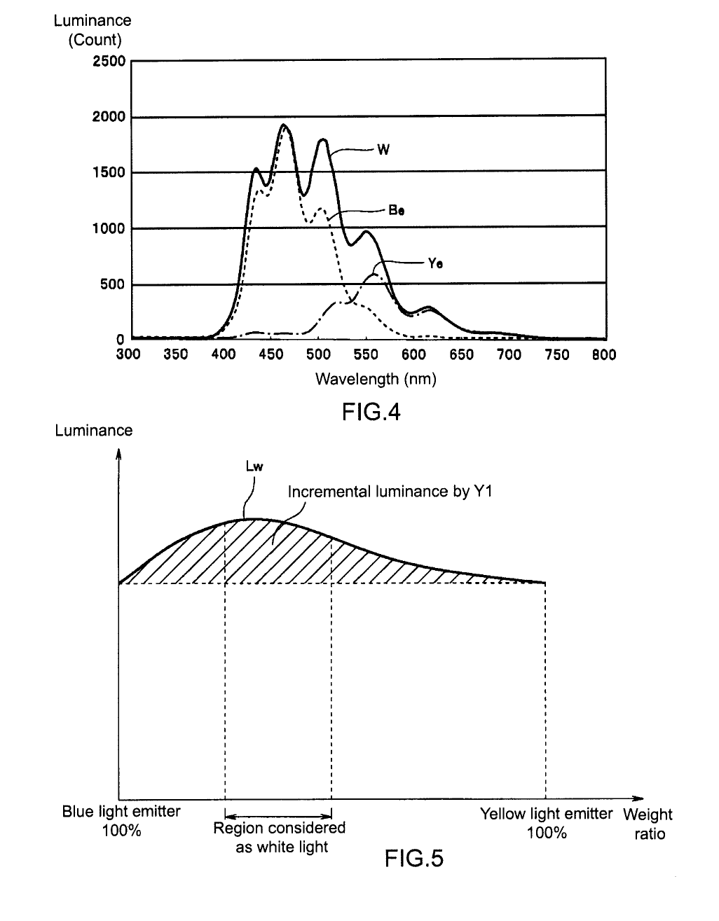

Hereinafter, embodiments of the present invention are explained with reference to the drawings. The drawings relate to an embodiment of the present invention: FIG. 1 is a basic construction view; FIG. 2 is an expanded schematic view of the light emitter layer; FIG. 3 is an explanatory view of light emission upon excitation of a blue light emitter and a yellow light emitter; FIG. 4 is a diagram showing luminance distribution of the light emitted by a blue light emitter unit, a yellow light emitter unit, and each light emitter of a mixed emitter thereof; FIG. 5 is a diagram showing the relationship between the weight ratio of the blue light emitter and yellow light emitter in a light emitter layer and luminance thereof.

As illustrated in FIG. 1, a light emitting apparatus 1 in the present embodiment is a light emitting apparatus used, for example, as a planar, field-emission type white illumination lamp, and has a basic construction in which a cathode 5, gate electrode 10, and anode 15 are arranged sequentially from the base plane side towards the light projection side, in a vacuum chamber 4 having glass substrates 2 and 3 oppositely arranged at a designated space therebetween.

The cathode 5 is composed of a conducting material formed on the glass substrate 2, which is a base plane, and is formed by depositing a metal such as aluminum, nickel, or the like, through vapor deposition, sputtering, or the like, or by applying a silver paste material, followed by drying, firing, or the like. A surface of the cathode 5 is coated with an emitter material in the shape of film such as carbon nanotubes, carbon nano-walls, Spindt type microcones, metal oxide whiskers, and the like, thereby forming a cold cathode electron emission source 6.

In the present embodiment, the cold cathode electron emission source 6 is patterned for every designated region; and around the patterned region (electron emission region) is arranged a cathode mask 7 which covers the cathode electrode 5.

The gate electrode 10 is constructed of a planar material having openings that allow passage of electrons emitted from the cold cathode electron emission source 6. Specifically, the gate electrode 10 is formed from a conductive metal plate of material such as nickel, stainless steel, Invar, and the like and has multiple openings 11 corresponding to the patterned region of the cold cathode electron emission source 6 with the elements thereof being formed by simple machinating and the like. The openings 11 of the gate electrode 10 are formed as circular holes the same size as, or a little larger than, the patterned region of the cold cathode electron emission source 6 formed as round in shape. This allows passage of essentially all the electrons emitted from the cold cathode electron emission source 6 therethrough so as to become effective electrons that contribute to light emission, thereby reducing power loss at the gate electrode 10 and enabling a loss-free gate to be produced.

The anode 15 is composed of a transparent electrically conductive film (for example, ITO film) arranged at the back side of the glass substrate 3 used as a light projection side; and at a side opposing the gate electrode 10 (cathode 5) is formed a light emitter layer 16 which emits light upon excitation by electrons emitted from the cold cathode electron emission source 6.

The light emitter layer 16 is composed of a mixture of multiple types of light emitters (fluorescent substance) which emit light with different wavelength bands upon excitation, where the mixing of light from each of these emitters generates white light. In the present embodiment, the light emitter layer 16 is composed of a mixture, for example, of a blue light emitter (a first light emitter) which emits blue light upon excitation and a yellow light emitter (a second light emitter) which emits yellow light upon excitation, which color is complementary to the blue light. In this case it is suitable for the blue light emitter to use a blue light emitter based on zinc sulfide (ZnS) with several ppm of an activator incorporated therein. This blue light emitter mainly emits blue light of 400 to 600 nm in wavelength with high emission efficiency upon electron excitation, as for example, shown by a dashed line in FIG. 4. On the other hand, it is suitable for the yellow light emitter to use an yttrium aluminum garnet (YAG)-based-yellow light emitter. This yellow light emitter mainly emits yellow light of 450 to 650 nm in wavelength with high emission efficiency upon electron excitation, as for example, shown by a dot-dashed line in FIG. 4. Furthermore, the YAG-based yellow light emitter also characteristically emits yellow light upon excitation by the blue light.

As shown in FIG. 2, the light emitter layer 16 is specifically formed by mixing blue light emitter particles 17 with yellow light emitter particles 18. Light emitter particles, 17 and 18, are each distributed being exposed at a surface of the light emitter layer 16; these exposed light emitter particles, 17 and 18 are each directly exposed to the electrons emitted from the cold cathode electron emission source 6 in the vacuum chamber 4.

Such light emitter layer 16 is formed, for example, by sequentially applying, onto the anode 15, a dispersion liquid containing yellow light emitter particles and a dispersion liquid containing blue light emitter particles by screen printing or the like, followed by a heat processing step, thereby removing the solvent etc. in the dispersion liquids. In this case both light emitter particles, 17 and 18, can be dispersed at a surface of the light emitter layer 16 by optimizing the concentration of each light emitter particle containing dispersion liquid, the amounts applied, the heat processing step conditions, and the like, thereby distributing and exposing each of light emitter particles, 17 and 18, with a designated density on the anode 15. More specifically, for example, when sequentially applying, onto the anode 15, a dispersion liquid containing yellow light emitter particles and a dispersion liquid containing blue light emitter particles, by especially increasing the ratio of the solvent contained in the blue emitter particles containing dispersion liquid, thereby distributing the blue light emitter particles at a prescribed low density, some of the yellow light emitter particles 18 are thus allowed to be exposed at the surface of the light emitter layer 16 in between the blue light emitter particles 17.

Then, for example, as shown in FIG. 3, the blue light emitter particles 17 are electronically excited by being directly exposed to electrons field-emitted from the cold cathode electron emission source 6, thereby emitting light as blue light Be. In the same manner the yellow light emitter particles 18 are electronically excited by being directly exposed to electrons field-emitted from the cold cathode electron emission source 6, thereby emitting light as yellow light Ye. Further, the yellow light emitter particles 18 are photo-excited by the blue light Be emitted by the adjacent blue light emitter particles 17, thereby emitting yellow light Y1. The blue light Be and the yellow lights Ye and Y1 are mixed on the projection plane side of the glass substrate 3, thereby efficiently emitting high luminance white light W.

That is, having the blue light emitter particles 17 and the yellow light emitter particles 18 exposed at a surface of the light emitter layer 16 allows each of the light emitter particles 17 and 18 to be directly exposed to the electrons, thereby allowing both the blue light and yellow light to emit through electron excitation more efficiently than when, for example, a light emitter layer is formed by superimposing in discrete layers the blue light emitter particles 17 and the yellow light emitter particles 18. Moreover, the blue light emitter particles 17 and the yellow light emitter particles 18 respectively do not need to be exposed completely. Even when other materials such as glass or silica is present on the surface of the light emitter layer or in between the particles, as long as the respective material has a characteristic of allowing field-emitted electrons to pass through, each of the light emitter particles 17 and 18 are directly exposed to the electrons and thus the same effect is achieved.

Further, since the yellow light emitter particles 18 in the present embodiment have characteristics such that they emit light upon excitation not only by electrons but also by the blue light, an effective use of the blue light can help improve the yellow light luminance, even when part of the blue light emitted by electron excitation, as it passes through the light emitter layer 16, is blocked by the yellow light emitter particles 18.

That is, where the blue light emitter monochromatic light emission luminance by electronic excitation is Lb, the yellow light emitter monochromatic luminance by electronic excitation is Ly, and the mixed ratio of the blue light emitter is A:B (where A+B=1), then in general, the luminance Lw of white light W generated by mixing blue light and yellow light by electron excitation of each light emitter is a weighted average of each luminance, as related by

Lw=A×Lb+B×Ly

In addition thereto, in the present embodiment, the white light luminance of the light emitter layer 16 can be increased by the extent to which the yellow light emitter particles 18 are also excited by the blue light thereby to emit light. For example, as shown by a solid line in FIG. 5, the luminance of the white light obtained in the light emitter layer 16 in the present embodiment is higher than the weighted average value of each luminance of the blue light and yellow light by electron excitation.

Herein, the mixing ratio of the blue light emitter particles 17 and the yellow light emitter particles 18 in the light emitter layer 16 is set up after consideration was taken of the luminance of the yellow light emitted upon photoexcitation by the blue light. In this case, the effect of the yellow light emitted upon photoexcitation by the blue light on the luminance Lw of the white light varies with the weight ratio of the blue light emitter and yellow light emitter. That is, the greater the ratio of the blue light emitter, the greater the luminance of the yellow light Y1 that the yellow light emitter per unit weight emits by photoexcitation. On the other hand as the ratio of the blue light emitter reaches a designated level or greater, the absolute amount of the yellow light emitter drops, reducing the ratio of the luminance of the yellow light Y1 by photoexcitation with respect to the overall white light luminance Lw. Taking into consideration the effect of the yellow light Y1 by photoexcitation leads to generation of ideal white light if the weight ratio of the blue light emitter and yellow light emitter is, for example, in a range from 3:1 to 1:1, such as that shown in FIG. 5.

The present embodiment as above enables white light to be generated, without using low-emission efficiency white light emitters, by forming a light emitter layer 16 using a high-light emission efficiency blue light emitter and yellow light emitter. In that case, by distributing at least a part of the blue light emitter particles 17 and at least a part of the yellow light emitter particles 18 exposed at a surface of the light emitter layer 16, respectively, allows both of such particles to be directly bombarded with electrons thereby effecting a highly efficient electronic excitation. Furthermore, use of YAG or the like, as a yellow light emitter, which emits light as yellow light not only by electron excitation but also through photoexcitation by the blue light permits the blue light to contribute to the emission of the yellow light, even when part of the blue light emitted by the blue light emitter particles, as it passes through the light emitter layer 16, is blocked by the yellow light emitter particles 18, whereby white light can be generated efficiently with a reduction in energy loss.

While the above embodiment was described for an example with an emitter layer formed by mixing two types of light emitters: a blue light emitter and a yellow light emitter, or mixing more than three types of light emitters, the present invention is not limited to that and it is possible to form a light emitter layer by mixing two, three, or more types of other color light emitters.

What is claimed is:

1. A light emitting apparatus, comprising, in a vacuum chamber,
a cathode having a cold cathode emission source formed thereon;
an anode having a light emitter layer, which is formed on a surface facing said cathode, and in which multiple types of light emitters that emit light upon excitation by field-emitted electrons from said cold cathode emission source are mixed; wherein
said multiple types of light emitters are each related such that white light is generated by a mixing of each emitted light, and are each dispersed in said light emitter layer so that at least a part of each emitter is exposed directly to said field-emitted electron; and wherein
at least one type of said light emitters also specifically emits light upon excitation by the light from another type of said light emitters.

2. A light emitting apparatus, comprising, in a vacuum chamber,
a cathode having a cold cathode emission source formed thereon;
an anode having a light emitter layer, which is formed on a surface facing said cathode, and in which multiple types of light emitters that emit light upon excitation by field-emitted electrons from said cold cathode emission source are mixed; wherein
said multiple types of light emitters are each related such that white light is generated by a mixing of each emitted light, and are each exposed at a surface of said light emitter layer; and wherein
at least one type of said light emitters also specifically emits light upon excitation by the light from another type of said light emitters.

3. The light emitting apparatus as set forth in claim 1, wherein
said light emitter layer comprises a mixture of a first light emitter which emits blue light upon excitation and a second light emitter which emits yellow light upon excitation; and wherein
said second light emitter emits yellow light upon excitation by the blue light emitted from said first light emitter.

4. The light emitting apparatus as set forth in claim 2, wherein
said light emitter layer comprises a mixture of a first light emitter which emits blue light upon excitation and a second light emitter which emits yellow light upon excitation; and
wherein
said second light emitter emits yellow light upon excitation by the blue light emitted from said first emitter.

5. The light emitting apparatus as set forth in claim 3, wherein
the weight ratio of said first light emitter and said second light emitter is set up within a range of from 3:1 to 1:1.

6. The light emitting apparatus as set forth in claim 4, wherein
the weight ratio of said first light emitter and said second light emitter is set up within a range of from 3:1 to 1:1.
